(19) United States
(12) Patent Application Publication
(10) Pub. No.: US 2025/0333190 A1
(43) Pub. Date: Oct. 30, 2025

(54) SYSTEMS, APPARATUSES, METHODS, AND COMPUTER PROGRAM PRODUCTS FOR AIRCRAFT SYSTEM SECURITY

(71) Applicant: Honeywell International Inc., Charlotte, NC (US)

(72) Inventors: Ravikumar Selvarajan, Madurai (IN); Sreenivasan Govindillam, Bangalore (IN); Rakshith B N, Bangalore (IN); Ramakrishnan Raman, Bangalore (IN)

(21) Appl. No.: 18/923,035

(22) Filed: Oct. 22, 2024

(30) Foreign Application Priority Data
Apr. 29, 2024 (IN) 202411033848

(51) Int. Cl. B64F 5/60; G06F 11/07

(52) U.S. Cl. CPC B64F 5/60; G06F 11/0739; G06F 11/079

(57) ABSTRACT

Systems, apparatuses, methods, and computer program products are provided herein. For example, a method may include receiving aviation data from an unverified device. In some embodiments, the method may include processing the aviation data using a first portion of a composite aviation operations verification model to identify an aviation related error associated with the aviation data. In some embodiments, the method may include, in an instance in which the aviation related error is not identified in the aviation data, initiating performance of one or more aviation related actions based at least in part on the aviation related error not being identified by the processing of the aviation data using the first portion of the composite aviation operations verification model.

### CROSS REFERENCE TO RELATED APPLICATIONS

This application claims the benefit of India Provisional Patent Application No. 20/241,1033848, filed Apr. 29, 2024, the entire contents of which are incorporated by reference herein.

### TECHNOLOGICAL FIELD

Embodiments of the present disclosure relate generally to systems, apparatuses, methods, and computer program products for initiating performance of one or more aviation related actions.

### BACKGROUND

Applicant has identified many technical challenges and difficulties associated with systems, apparatuses, methods, and computer program products for initiating performance of one or more aviation related actions. Through applied effort, ingenuity, and innovation, Applicant has solved problems related to systems, apparatuses, methods, and computer program products for initiating performance of one or more aviation related actions by developing solutions embodied in the present disclosure, which are described in detail below.

### BRIEF SUMMARY

Various embodiments described herein relate to systems, apparatuses, methods, and computer program products for initiating performance of one or more aviation related actions.

In accordance with one aspect of the disclosure, a method is provided. In some embodiments, the method may include receiving aviation data from an unverified device. In some embodiments, the method may include processing the aviation data using a first portion of a composite aviation operations verification model to identify an aviation related error associated with the aviation data. In some embodiments, the method may include in an instance in which the aviation related error is not identified in the aviation data, initiating performance of one or more aviation related actions based at least in part on the aviation related error not being identified by the processing of the aviation data using the first portion of the composite aviation operations verification model.

In some embodiments, initiating performance of one or more aviation related actions based at least in part on the aviation related error not being identified by the processing of the aviation data using the first portion of the composite aviation operations verification model comprises initiating performance of a first aviation related action that comprises transmitting the aviation data to one or more verified devices.

In some embodiments, the verified device is a flight management system.

In some embodiments, the flight management system is physically located on an aircraft.

In some embodiments, initiating performance of one or more aviation related actions based at least in part on the aviation related error not being identified by the processing of the aviation data using the first portion of the composite aviation operations verification model comprises initiating performance of a first aviation related action that comprises causing operation of one or more verified devices based at least in part on the aviation data.

In some embodiments, processing the aviation data using the first portion of the composite aviation operations verification model comprises applying the aviation data to a syntactic validator component of the first portion of the composite aviation operations verification model to identify the aviation related error.

In some embodiments, processing the aviation data using the first portion of the composite aviation operations verification model comprises applying the aviation data to a semantic constraint check component of the first portion of the composite aviation operations verification model to identify the aviation related error.

In some embodiments, processing the aviation data using the first portion of the composite aviation operations verification model comprises applying the aviation data to a semantic constraint machine learning model of the first portion of the composite aviation operations verification model to identify the aviation related error.

In some embodiments, the method may include training the semantic constraint machine learning model based at least in part on verified aviation data.

In some embodiments, the method may include in an instance in which the aviation related error is identified in the aviation data, processing the aviation related error using a second portion of the composite aviation operations verification model.

In some embodiments, the method may include initiating performance of one or more aviation related actions based at least in part on the processing of the aviation related error using the second portion of the composite aviation operations verification model.

In some embodiments, initiating performance of one or more aviation related actions based at least in part on the processing of the aviation related error using the second portion of the composite aviation operations verification model comprises initiating performance of a first aviation related action that comprises transmitting an aviation alert to one or more verified devices.

In some embodiments, wherein initiating performance of one or more aviation related actions based at least in part on the processing of the aviation related error using the second portion of the composite aviation operations verification model comprises initiating performance of a first aviation related action that comprises providing an indication of the aviation related error to the unverified device.

In some embodiments, wherein initiating performance of one or more aviation related actions based at least in part on the processing of the aviation related error using the second portion of the composite aviation operations verification model comprises initiating performance of a first aviation related action that comprises causing operation of one or more verified devices based at least in part on the aviation related error.

In some embodiments, processing the aviation data using the second portion of the composite aviation operations verification model comprise applying the aviation related error to an uncertainty estimation component of the second portion of the composite aviation operations verification model to generate error impact data.

In accordance with another aspect of the disclosure, an apparatus is provided. In some embodiments, the apparatus may include at least one processor and at least one non-transitory memory including computer-coded instructions thereon. In some embodiments, the computer-coded instructions, with the at least one processor, cause the apparatus to receive aviation data from an unverified device. In some embodiments, the computer-coded instructions, with the at least one processor, cause the apparatus to process the aviation data using a first portion of a composite aviation operations verification model to identify an aviation related error associated with the aviation data. In some embodiments, the computer-coded instructions, with the at least one processor, cause the apparatus to in an instance in which the aviation related error is not identified in the aviation data, initiate performance of one or more aviation related actions based at least in part on the aviation related error not being identified by the processing of the aviation data using the first portion of the composite aviation operations verification model.

In some embodiments, initiating performance of one or more aviation related actions based at least in part on the aviation related error not being identified by the processing of the aviation data using the first portion of the composite aviation operations verification model comprises initiating performance of a first aviation related action that comprises transmitting the aviation data to one or more verified devices.

In some embodiments, the verified device is a flight management system.

In some embodiments, the flight management system is physically located on an aircraft.

In some embodiments, initiating performance of one or more aviation related actions based at least in part on the aviation related error not being identified by the processing of the aviation data using the first portion of the composite aviation operations verification model comprises initiating performance of a first aviation related action that comprises causing operation of one or more verified devices based at least in part on the aviation data.

In some embodiments, processing the aviation data using the first portion of the composite aviation operations verification model comprises applying the aviation data to a syntactic validator component of the first portion of the composite aviation operations verification model to identify the aviation related error.

In some embodiments, processing the aviation data using the first portion of the composite aviation operations verification model comprises applying the aviation data to a semantic constraint check component of the first portion of the composite aviation operations verification model to identify the aviation related error.

In some embodiments, processing the aviation data using the first portion of the composite aviation operations verification model comprises applying the aviation data to a semantic constraint machine learning model of the first portion of the composite aviation operations verification model to identify the aviation related error.

In some embodiments, the computer-coded instructions, with the at least one processor, cause the apparatus to train the semantic constraint machine learning model based at least in part on verified aviation data.

In some embodiments, the computer-coded instructions, with the at least one processor, cause the apparatus to in an instance in which the aviation related error is identified in the aviation data, process the aviation related error using a second portion of the composite aviation operations verification model.

In some embodiments, the computer-coded instructions, with the at least one processor, cause the apparatus to initiate performance of one or more aviation related actions based at least in part on the processing of the aviation related error using the second portion of the composite aviation operations verification model.

In some embodiments, initiating performance of one or more aviation related actions based at least in part on the processing of the aviation related error using the second portion of the composite aviation operations verification model comprises initiating performance of a first aviation related action that comprises transmitting an aviation alert to one or more verified devices.

In some embodiments, wherein initiating performance of one or more aviation related actions based at least in part on the processing of the aviation related error using the second portion of the composite aviation operations verification model comprises initiating performance of a first aviation related action that comprises providing an indication of the aviation related error to the unverified device.

In some embodiments, wherein initiating performance of one or more aviation related actions based at least in part on the processing of the aviation related error using the second portion of the composite aviation operations verification model comprises initiating performance of a first aviation related action that comprises causing operation of one or more verified devices based at least in part on the aviation related error.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving aviation data from an unverified device. In some embodiments, the computer program code, in execution with at least one processor, configures the computer program product for processing the aviation data using a first portion of a composite aviation operations verification model to identify an aviation related error associated with the aviation data. In some embodiments, the computer program code, in execution with at least one processor, configures the computer program product for in an instance in which the aviation related error is not identified in the aviation data, initiating performance of one or more aviation related actions based at least in part on the aviation related error not being identified by the processing of the aviation data using the first portion of the composite aviation operations verification model.

In some embodiments, initiating performance of one or more aviation related actions based at least in part on the aviation related error not being identified by the processing of the aviation data using the first portion of the composite aviation operations verification model comprises initiating performance of a first aviation related action that comprises transmitting the aviation data to one or more verified devices.

In some embodiments, the verified device is a flight management system.

In some embodiments, the flight management system is physically located on an aircraft.

In some embodiments, initiating performance of one or more aviation related actions based at least in part on the aviation related error not being identified by the processing of the aviation data using the first portion of the composite aviation operations verification model comprises initiating performance of a first aviation related action that comprises causing operation of one or more verified devices based at least in part on the aviation data.

In some embodiments, processing the aviation data using the first portion of the composite aviation operations verification model comprises applying the aviation data to a syntactic validator component of the first portion of the composite aviation operations verification model to identify the aviation related error.

In some embodiments, processing the aviation data using the first portion of the composite aviation operations verification model comprises applying the aviation data to a semantic constraint check component of the first portion of the composite aviation operations verification model to identify the aviation related error.

In some embodiments, processing the aviation data using the first portion of the composite aviation operations verification model comprises applying the aviation data to a semantic constraint machine learning model of the first portion of the composite aviation operations verification model to identify the aviation related error.

In some embodiments, the computer program code, in execution with at least one processor, configures the computer program product for training the semantic constraint machine learning model based at least in part on verified aviation data.

In some embodiments, the computer program code, in execution with at least one processor, configures the computer program product for in an instance in which the aviation related error is identified in the aviation data, processing the aviation related error using a second portion of the composite aviation operations verification model.

In some embodiments, the computer program code, in execution with at least one processor, configures the computer program product for initiating performance of one or more aviation related actions based at least in part on the processing of the aviation related error using the second portion of the composite aviation operations verification model.

In some embodiments, initiating performance of one or more aviation related actions based at least in part on the processing of the aviation related error using the second portion of the composite aviation operations verification model comprises initiating performance of a first aviation related action that comprises transmitting an aviation alert to one or more verified devices.

In some embodiments, wherein initiating performance of one or more aviation related actions based at least in part on the processing of the aviation related error using the second portion of the composite aviation operations verification model comprises initiating performance of a first aviation related action that comprises providing an indication of the aviation related error to the unverified device.

In some embodiments, wherein initiating performance of one or more aviation related actions based at least in part on the processing of the aviation related error using the second portion of the composite aviation operations verification model comprises initiating performance of a first aviation related action that comprises causing operation of one or more verified devices based at least in part on the aviation related error.

In some embodiments, processing the aviation data using the second portion of the composite aviation operations verification model comprise applying the aviation related error to an uncertainty estimation component of the second portion of the composite aviation operations verification model to generate error impact data.

In some embodiments, processing the aviation data using the second portion of the composite aviation operations verification model comprise applying the error impact data to an error handling component of the second portion of the composite aviation operations verification model.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an example composite aviation operations verification model in accordance with one or more embodiments of the present disclosure;

FIG. 4 illustrates an interface component in accordance with one or more embodiments of the present disclosure;

FIG. 5 illustrates an interface component in accordance with one or more embodiments of the present disclosure;

FIG. 6 illustrates an interface component in accordance with one or more embodiments of the present disclosure;

FIG. 7 illustrates an interface component in accordance with one or more embodiments of the present disclosure; and

FIG. 8 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with initiating performance of one or more aviation related actions. As would be understood by one skilled in the field to which this disclosure pertains, there are numerous example scenarios in which it may be desirable to initiate performance of one or more aviation related actions.

In many applications, systems, apparatuses, methods, and computer program products for initiating performance of one or more aviation related actions are desirable. In some implementations it may be desirable to initiate performance of one or more aviation related actions based on aviation data received from and/or generated by unverified devices. For example, it may be desirable to use an unverified device associated with an aircraft (e.g., a pilot's mobile electronic device) to download and/or generate flight plans that can then be used by verified components of an aircraft (e.g., an aircraft's flight management system) to perform aviation related actions related to the operation of the aircraft. In this way, vast amounts of open world aviation data can be dynamically leveraged to enable verified devices associated with an aircraft to implement a variety of aviation related actions.

Example solutions for initiating performance of one or more aviation related actions include using verified devices and/or verified aviation data to implement the one or more aviation related actions. In such example solutions, verified devices are used because these devices have undergone a regulatory approval process to be used in an aircraft. However, as a result, such example solutions are often deficient because the capabilities of verified devices used in such example solutions often lag behind unverified devices due to the burden in updating and/or replacing verified devices (e.g., due to the regulatory burdens). In such example solutions, verified aviation data is used because verified aviation data is less susceptible to errors being introduced into the data by accident (e.g., a mistake is made during the generation of a flight plan) and/or by a malicious actor (e.g., a malicious actor that may purposefully introduce mistakes into a flight plan to cause harm). However, as a result, such example solutions are often deficient because such example solutions are unable to dynamically leverage the vast amount of open world aviation data for initiating performance of aviation related actions (e.g., such example solutions are restricted to using the small amount of verified aviation data). Accordingly, there is a need for systems, apparatuses, methods, and computer program products that are capable of initiating performance of one or more aviation related actions based on aviation data received from and/or generated by unverified devices.

Thus, to address these and/or other issues related to such example solutions, example systems, apparatuses, methods, and computer program products for initiating performance of one or more aviation related actions are disclosed herein. For example, an embodiment in this disclosure, described in greater detail below, includes a method that includes receiving aviation data from an unverified device. In some embodiments, the method includes processing the aviation data using a first portion of a composite aviation operations verification model to identify an aviation related error associated with the aviation data. In some embodiments, the method includes, in an instance in which the aviation related error is not identified in the aviation data, initiating performance of one or more aviation related actions based at least in part on the aviation related error not being identified by the processing of the aviation data using the first portion of the composite aviation operations verification model. Accordingly, the systems, apparatuses, methods, and computer program products disclosed herein enable for initiating performance of one or more aviation related actions based at least in part on aviation data received from and/or generated by an unverified device.

### Example Systems and Apparatuses

Embodiments of the present disclosure herein include systems, apparatuses, methods, and computer program products configured for initiating performance of one or more aviation related actions. It should be readily appreciated that the embodiments of the apparatus, systems, methods, and computer program product described herein may be configured in various additional and alternative manners in addition to those expressly described herein.

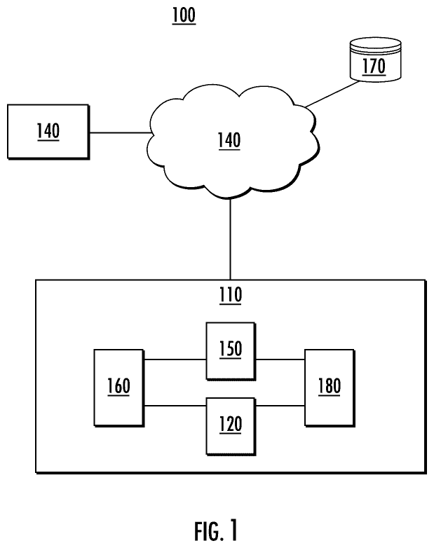

FIG. 1 illustrates an example block diagram of an environment 100 in which embodiments of the present disclosure may operate. Specifically, FIG. 1 illustrates an aircraft 110. In some embodiments, the aircraft 110 may describe any machine, robot, computing devices, and/or apparatus comprised of hardware, software, firmware, and/or any combination thereof, that maneuvers throughout an environment through a medium, such as air. In some contexts, the aircraft 110 is utilized to transport objects, entities (e.g., people, animals, or other beings), or other onboard cargo. In some situations, the aircraft 110 may be transporting no object except for the aircraft itself. Examples of the aircraft 110 include airplanes, helicopters, drones, and/or the like. In some embodiments, the aircraft 110 is not limited to the examples listed herein and may include other types of transportation device.

In some embodiments, the aircraft 110 may include any number of individual components. The components of the aircraft 110 may perform a particular function during operation of the aircraft 110. For example, the components may include one or more multi-function control and display unit (MCDU) components, flight management system (FMS) components, inertial reference system (IRS) components, sensor components, actuator components, primary flight display (PFD) components, and/or the like. In this regard, for example, the individual components of the aircraft 110 may include components associated with a particular process or operation performed by the aircraft 110.

In some embodiments, each individual component of the aircraft 110 is associated with a determinable location. The determinable location of a particular component in some embodiments represents an absolute position (e.g., GPS coordinates, latitude, and longitude locations, and/or the like) or a relative position (e.g., a point representation of the location of a component from a local origin point corresponding to the aircraft 110). In some embodiments, a component includes or otherwise is associated with a location sensor and/or software-driven location services that provide the location data representing the location corresponding to that component. In other embodiments the location of a component is stored and/or otherwise predetermined within a software environment, provided by a user and/or otherwise determinable to one or more systems.

Additionally, or alternatively, in some embodiments, the aircraft 110 itself is associated with a determinable location. The determinable location of the aircraft 110 in some embodiments represents an absolute position (e.g., GPS coordinates, latitude and longitude locations, an address, and/or the like) or a relative position of the aircraft 110 (e.g., an identifier representing the location of the aircraft 110 as compared to one or more other aircrafts, one or more buildings (e.g., an airport), an enterprise headquarters, or general description in the world for example based at least in part on continent, state, or other definable region). In some embodiments, the aircraft 110 includes or otherwise is associated with a location sensor and/or software-driven location services that provide the location data corresponding to the aircraft 110. In other embodiments, the location of the aircraft 110 is stored and/or otherwise determinable to one or more systems.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

In some embodiments, the environment 100 may include one or more unverified devices 160. The one or more unverified devices 160 may be electronically and/or communicatively coupled to the aircraft 110, individual components of the aircraft 110, the aviation operations verification apparatus, the one or more verified devices 180, and/or the one or more databases 170. The one or more unverified devices 160 may be located remotely (e.g., in a control tower at an airport), in proximity of (e.g., in an electronic flight bag associated with the aircraft 110), and/or within the aircraft 110 (e.g., as an onboard component of the aircraft 110). In some embodiments, the one or more unverified devices 160 may be associated with unverified aviation data. In some embodiments, the one or more unverified devices 160 may be associated with an open world. In this regard, for example, the one or more unverified devices 160 may be devices that have not received approval from a regulatory entity associated with the aircraft 110 (e.g., devices that have not received approval from the Federal Aviation Administration and/or another regulatory entity).

In some embodiments, the environment 100 may include one or more verified devices 180. The one or more verified devices 180 may be electronically and/or communicatively coupled to the aircraft 110, individual components of the aircraft 110, the aviation operations verification apparatus, one or more verified devices 180, and/or one or more databases 170. Additionally, or alternatively, the one or more verified devices 180 may be a component of the aircraft 110 and may be electronically and/or communicatively coupled to the aircraft 110, the aviation operations verification apparatus, the one or more verified devices 180, and/or the one or more databases 170 The one or more verified devices 180 may be located remotely (e.g., in a control tower at an airport), in proximity of (e.g., in an electronic flight bag associated with the aircraft 110), and/or within the aircraft 110 (e.g., as an onboard component of the aircraft 110). For example, the one or more verified devices 180 may include a flight management system component of the aircraft 110. In some embodiments, the one or more verified devices 180 may be associated with initiating performance of one or more aviation related actions.

In some embodiments, the environment 100 may include an aviation operations verification apparatus. In some embodiments, the aviation operations verification apparatus may be at least partially embodied as a mobile aviation operations verification apparatus 120. Additionally, or alternatively, the aviation operations verification apparatus may be at least partially embodied as an onboard aviation operations verification apparatus 150. Additionally, or alternatively, the aviation operations verification apparatus may be at least partially embodied as a remote aviation operations verification apparatus 140.

In some embodiments, for example, the aviation operations verification apparatus (e.g., the mobile aviation operations verification apparatus 120, the onboard aviation operations verification apparatus 150, and/or the remote aviation operations verification apparatus 140) may be configured to initiate performance of one or more aviation related actions. The aviation operations verification apparatus may be electronically and/or communicatively coupled to the aircraft 110, individual components of the aircraft 110, the one or more unverified devices 160, the one or more verified devices 180, and/or the one or more databases 170. The aviation operations verification apparatus may be located remotely (e.g., in a control tower at an airport), in proximity of (e.g., in an electronic flight bag associated with the aircraft 110), and/or within the aircraft 110 (e.g., as an onboard component of the aircraft 110). In some embodiments, the aviation operations verification apparatus is configured via hardware, software, firmware, and/or a combination thereof, to perform data intake of one or more types of data associated with one or more of the aircraft 110, the one or more unverified devices 160, and/or the one or more verified devices 180. Additionally, or alternatively, in some embodiments, the aviation operations verification apparatus is configured via hardware, software, firmware, and/or a combination thereof, to generate and/or transmit command(s) that control, adjust, or otherwise impact operations of one or more of the aircraft 110, the one or more unverified devices 160, the one or more verified devices 180, and/or or specific component(s) of the aircraft 110, for example for controlling one or more operations of the aircraft 110. Additionally or alternatively still, in some embodiments, the aviation operations verification apparatus is configured via hardware, software, firmware, and/or a combination thereof, to perform data reporting and/or other data output process(es) associated with monitoring or otherwise analyzing operations of one or more of the aircraft 110 the one or more unverified devices 160, the one or more verified devices 180, and/or or specific component(s) of the aircraft 110, for example for generating and/or outputting report(s) corresponding to the operations performed via the aircraft 110. For example, in various embodiments, the aviation operations verification apparatus may be configured to execute and/or perform one or more operations and/or functions described herein.

The one or more databases 170 may be configured to receive, store, and/or transmit data. In some embodiments, the one or more databases 170 may be associated with unverified aviation data, verified aviation data, and/or error impact data.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the aviation operations verification apparatus may include the one or more databases 170.

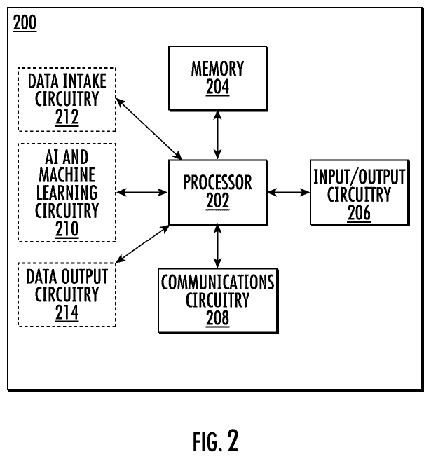

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, aviation operations verification apparatus (e.g., the mobile aviation operations verification apparatus 120, the onboard aviation operations verification apparatus 150, and/or the remote aviation operations verification apparatus 140), the one or more databases 170, the one or more unverified devices 160, the one or more verified devices 180, and/or the aircraft 110. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of aviation operations verification apparatus (e.g., the mobile aviation operations verification apparatus 120, the onboard aviation operations verification apparatus 150, and/or the remote aviation operations verification apparatus 140) may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the aircraft 110. In some embodiments, the data intake circuitry 212 includes hardware, software, firmware, and/or a combination thereof, that communicates with one or more sensor(s) component(s), and/or the like within the aircraft 110 to receive particular data associated with such operations of the aircraft 110. Additionally, or alternatively, in some embodiments, the data intake circuitry 212 includes hardware, software, firmware, and/or a combination thereof, that retrieves particular data associated with the aircraft 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

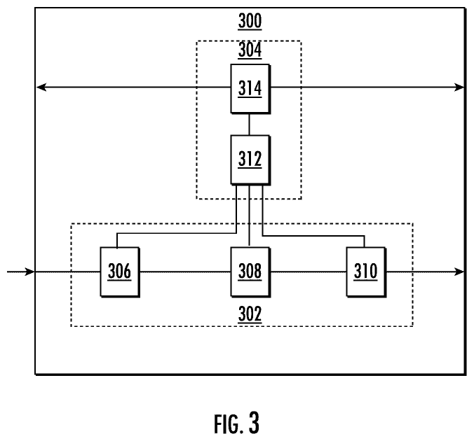

With reference to FIGS. 1-7, in some embodiments, the aviation operations verification apparatus (e.g., the mobile aviation operations verification apparatus 120, the onboard aviation operations verification apparatus 150, and/or the remote aviation operations verification apparatus 140) may be configured to receive aviation data. In some embodiments, the aviation operations verification apparatus may be configured to receive the aviation data from one or more of the one or more unverified devices 160. In this regard, for example, the one or more unverified devices 160 may be configured to generate aviation data.

In some embodiments, aviation data may be one or more items of data representative of and/or associated with a flight plan of an aircraft (e.g., the aircraft 110). In some embodiments, a flight plan may represent a series of operations the aircraft 110 may perform to complete a flight and/or a portion of a flight. Additionally, or alternatively, a flight plan may represent conditions associated with the aircraft 110 performing the flight. In this regard, for example, aviation data may include one or more items of data representative of and/or associated with a required runway to perform a flight (e.g., a runway of a certain length based on the size of the aircraft 110). As another example, aviation data may include one or more items of data representative of and/or associated with required fuel to perform a flight. As another example, aviation data may include one or more items of data representative of and/or associated with a time of arrival at a waypoint in a flight. As another example, aviation data may include one or more items of data representative of and/or associated with potential cross track errors in a flight. As another example, aviation data may include one or more items of data representative of and/or associated with real time traffic associated with a flight (e.g., other aircraft that may impact a flight performed by the aircraft 110).

As another example, aviation data may include one or more items of data representative of and/or associated with altitude at various points in a flight. As another example, aviation data may include one or more items of data representative of and/or associated with weather associated with a flight. As another example, aviation data may include one or more items of data representative of and/or associated with airport conditions associated with a flight (e.g., origin airport and/or destination airport). As another example, aviation data may include one or more items of data representative of and/or associated with air traffic control commands associated with a flight. As another example, aviation data may include one or more items of data representative of and/or associated with location (e.g., GPS location) at various points in a flight. As another example, aviation data may include one or more items of data representative of and/or associated with operation algorithms associated with controlling the aircraft 110 during a flight.

In some embodiments, the aviation operations verification apparatus (e.g., the mobile aviation operations verification apparatus 120, the onboard aviation operations verification apparatus 150, and/or the remote aviation operations verification apparatus 140) may be configured to process aviation data using a first portion 302 of a composite aviation operations verification model 300. In some embodiments, the aviation operations verification apparatus may be configured to process aviation data using the first portion 302 of the composite aviation operations verification model 300 to identify an aviation related error associated with the aviation data. In some embodiments, an aviation related error may indicate that there is an error in a flight plan associated with the aviation data. In this regard, for example, an aviation related error may indicate that the aircraft 110 may not be able to adhere to at least a portion of a flight plan.

In some embodiments, for example, an aviation related error may indicate that there is a range related error in the flight plan (e.g., the aircraft 110 is not capable of traveling the distance indicated in the flight plan). As another example, an aviation related error may indicate that there is a nonexistent identifier in the flight plan (e.g., a nonexistent waypoint, airport, airway, and/or the like in a flight plan). As another example, an aviation related error may indicate that there is insufficient fuel to complete a flight plan. As another example, an aviation related error may indicate that a selected runway is insufficient for the size of the aircraft 110 (e.g., the aircraft 110 is a large aircraft that needs a longer runway than the selected runway). As another example, an aviation related error may indicate that the planned trajectory of the aircraft 110 in a flight plan may result in a violation of a required navigational performance. As another example, an aviation related error may indicate that the fuel remaining at a waypoint may be too little to complete a flight associated with a flight plan. As another example, an aviation related error may indicate that a flight plan indicates an incorrect position (e.g., at a particular point in the flight). As another example, an aviation related error may indicate that a weight of the aircraft 110 is incorrect for takeoff. As another example, an aviation related error may indicate that weather conditions will not enable a planned trajectory.

In some embodiments, an aviation related error may be semantic related error. For example, a semantic related error may be an aviation related error in which a flight plan indicates that the destination airport is a valid airport (e.g., KLAX) while the actual intended destination airport is a different airport (e.g., KPHX). In some embodiments, an aviation related error may be a syntactic related error. For example, a syntactic related error may be an aviation related error in which there is a syntactic related error in text that describes the flight plan.

In some embodiments, the first portion 302 of the composite aviation operations verification model 300 may include a syntactic validator component 306. In this regard, for example, processing the aviation data using the first portion 302 of the composite aviation operations verification model 300 may include the aviation operations verification apparatus (e.g., the mobile aviation operations verification apparatus 120, the onboard aviation operations verification apparatus 150, and/or the remote aviation operations verification apparatus 140) being configured to apply the aviation data to the syntactic validator component 306. In some embodiments, the syntactic validator component 306 may be a data entity that describes parameters, hyper-parameters, and/or defined operations of a rules-based model (e.g., model including at least one of one or more rule-based layers) configured to at least in part identify an aviation related error associated with the aviation data using one or more syntactic based rules (e.g., to identify aviation related errors that are syntactic related errors).

In some embodiments, the first portion 302 of the composite aviation operations verification model 300 may include a semantic constraint check component 308. In this regard, for example, processing the aviation data using the first portion 302 of the composite aviation operations verification model 300 may include the aviation operations verification apparatus (e.g., the mobile aviation operations verification apparatus 120, the onboard aviation operations verification apparatus 150, and/or the remote aviation operations verification apparatus 140) being configured to apply the aviation data to the semantic constraint check component 308. In some embodiments, the semantic constraint check component 308 may be a data entity that describes parameters, hyper-parameters, and/or defined operations of a rules-based model (e.g., model including at least one of one or more rule-based layers) configured to at least in part identify an aviation related error associated with the aviation data using one or more semantic based rules (e.g., to identify aviation related errors that are semantic related errors).

In some embodiments, the first portion 302 of the composite aviation operations verification model 300 may include a semantic constraint machine learning model 310. In this regard, for example, processing the aviation data using the first portion 302 of the composite aviation operations verification model 300 may include the aviation operations verification apparatus (e.g., the mobile aviation operations verification apparatus 120, the onboard aviation operations verification apparatus 150, and/or the remote aviation operations verification apparatus 140) being configured to apply the aviation data to the semantic constraint machine learning model 310.

In some embodiments, the semantic constraint machine learning model 310 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to at least in part identify an aviation related error associated with the aviation data using one or more machine learning techniques. The semantic constraint machine learning model 310 may utilize one or more of any type of machine learning, rules-based, and/or artificial intelligence techniques including one or more of supervised learning (e.g., using user feedback), unsupervised learning, semi-supervised learning, reinforcement learning, computer vision techniques, sequence modeling techniques, language processing techniques, neural network techniques, and/or generative artificial intelligence techniques.

In some embodiments, the aviation operations verification apparatus (e.g., the mobile aviation operations verification apparatus 120, the onboard aviation operations verification apparatus 150, and/or the remote aviation operations verification apparatus 140) may be configured to train the semantic constraint machine learning model 310. In this regard, for example, the aviation operations verification apparatus may be configured to train the semantic constraint machine learning model 310 based at least in part on verified aviation data. In some embodiments, verified aviation data may be one or more items of data representative of and/or associated with a flight plan of an aircraft (e.g., the aircraft 110) that does not include any aviation related errors. For example, verified aviation data may be aviation data that was previously processed by the composite aviation operations verification model in which no aviation related errors were identified.

In some embodiments, the aviation operations verification apparatus (e.g., the mobile aviation operations verification apparatus 120, the onboard aviation operations verification apparatus 150, and/or the remote aviation operations verification apparatus 140), in an instance in which an aviation related error is not identified in the aviation data, may be configured to initiate performance of one or more aviation related actions based at least in part on an aviation related error not being identified by the processing of the aviation data using the first portion 302 of the composite aviation operations verification model 300. In this regard, for example, the aviation operations verification apparatus may be configured to initiate performance of one or more aviation related actions when an aviation related error is not identified by the processing of the aviation data using the first portion 302 of the composite aviation operations verification model 300.

In some embodiments, initiating performance of one or more aviation related actions based at least in part on the aviation related error not being identified by the processing of the aviation data using the first portion 302 of the composite aviation operations verification model 300 may include initiating performance of an aviation related action that includes transmitting the aviation data to one or more of the one or more verified devices 180. For example, the aviation operations verification apparatus may be configured to initiate performance of an aviation related action that includes transmitting the aviation data to a flight management system component of the aircraft 110 (e.g., the flight management system component may be a verified device). In this regard, for example, the flight management system component may be configured to implement a flight plan, a portion of a flight plan, and/or an operation in a flight plan associated with the aviation data based at least in part on the transmitted aviation data (e.g., the transmitted aviation data is used to implement a flight plan, a portion of a flight plan, and/or an operation in a flight plan).

In some embodiments, initiating performance of one or more aviation related actions based at least in part on the aviation related error not being identified by the processing of the aviation data using the first portion 302 of the composite aviation operations verification model 300 may include initiating performance of an aviation related action that includes causing operation of one or more of the one or more verified devices 180. For example, the aviation operations verification apparatus may be configured to initiate performance of an aviation related action that includes causing operation of a flight management system component of the aircraft 110 (e.g., the flight management system component may be a verified device). In this regard, for example, the aviation operations verification apparatus may be configured to cause the flight management system component to implement a flight plan, a portion of a flight plan, and/or an operation in a flight plan associated with the aviation data.

In some embodiments, in an instance in which an aviation related error is identified in the aviation data, the aviation operations verification apparatus (e.g., the mobile aviation operations verification apparatus 120, the onboard aviation operations verification apparatus 150, and/or the remote aviation operations verification apparatus 140) may be configured to process the aviation related error using a second portion 304 of the composite aviation operations verification model 300.

In some embodiments, the second portion 304 of the composite aviation operations verification model 300 may include an uncertainty estimation component 312. In this regard, for example, processing the aviation related error using the second portion 304 of the composite aviation operations verification model 300 may include the aviation operations verification apparatus (e.g., the mobile aviation operations verification apparatus 120, the onboard aviation operations verification apparatus 150, and/or the remote aviation operations verification apparatus 140) being configured to apply the aviation related error to the uncertainty estimation component 312. In some embodiments, the aviation operations verification apparatus may apply the aviation related error to the uncertainty estimation component 312 to generate error impact data.

In some embodiments, error impact data by one or more items of data representative of an impact of an aviation related error. In this regard, for example, error impact data may indicate whether an aviation related error is an acceptable error or an unacceptable error. In some embodiments, if an aviation related error is an acceptable error, the aircraft 110 may be able to use a flight plan associated with the aviation data to perform a flight even though the flight plan includes an error. For example, if the flight plan indicates that the aircraft 110 should maintain an altitude of 32,000 feet during a portion of the flight but the processing of the aviation data in the first portion 302 of the composite aviation operations verification model 300 identifies an aviation related error that indicates that the aircraft may be at 32,100 feet during the portion of the flight, the uncertainty estimation component 312 may generate error impact data that indicates that the aviation related error is an acceptable error.

In some embodiments, if an aviation related error is an unacceptable error, the aircraft 110 may not be able to use the flight plan associated with the aviation data to perform a flight. For example, if the flight plan indicates that the aircraft 110 should land at a first runway but the processing of the aviation data in the first portion 302 of the composite aviation operations verification model 300 identifies an aviation related error that indicates that the first runway is too short of the aircraft to land at, the uncertainty estimation component 312 may generate error impact data that indicates that the aviation related error is an unacceptable error.

In some embodiments, the uncertainty estimation component 312 may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to at least in part generate error impact data. The uncertainty estimation component 312 may utilize one or more of any type of machine learning, rules-based, and/or artificial intelligence techniques including one or more of supervised learning (e.g., using user feedback), unsupervised learning, semi-supervised learning, reinforcement learning, computer vision techniques, sequence modeling techniques, language processing techniques, neural network techniques, and/or generative artificial intelligence techniques.

In some embodiments, the second portion 304 of the composite aviation operations verification model 300 may include an error handling component 314. In this regard, for example, processing the aviation related error using the second portion 304 of the composite aviation operations verification model 300 may include the aviation operations verification apparatus (e.g., the mobile aviation operations verification apparatus 120, the onboard aviation operations verification apparatus 150, and/or the remote aviation operations verification apparatus 140) being configured to apply error impact data to the error handling component 314. In some embodiments, the error handling component 314 may be a data entity that describes parameters, hyper-parameters, and/or defined operations of a rules-based model (e.g., model including at least one of one or more rule-based layers) configured to at least in part handle error impact data and/or aviation data.

In some embodiments, the aviation operations verification apparatus (e.g., the mobile aviation operations verification apparatus 120, the onboard aviation operations verification apparatus 150, and/or the remote aviation operations verification apparatus 140) may be configured to initiate performance of one or more aviation related actions based at least in part on the processing of the aviation related error using the second portion 304 of the composite aviation operations verification model 300. In some embodiments, the aviation operations verification apparatus may be configured to initiate performance of one or more aviation related actions based at least in part on the processing of the aviation related error using the second portion 304 of the composite aviation operations verification model 300 using the error handling component 314.

In some embodiments, initiating performance of one or more aviation related actions based at least in part on the processing of the aviation related error using the second portion 304 of the composite aviation operations verification model 300 may include initiating performance of an aviation related action that includes providing an indication of an identified aviation related error to one or more of the one or more unverified devices 160 (e.g., using the error handling component 314). In this regard, the aviation operations verification apparatus may be configured to provide feedback to one or more of the one or more unverified devices 160 when an aviation related error has been identified.

In some embodiments, initiating performance of one or more aviation related actions based at least in part on the processing of the aviation related error using the second portion 304 of the composite aviation operations verification model 300 may include initiating performance of an aviation related action that includes transmitting an aviation alert to one or more of the one or more verified devices 180 (e.g., using the error handling component 314). In some embodiments, the transmitted aviation alert may include an indication that there is an aviation related error associated with the aviation data. In some embodiments, the transmitted aviation alert may indicate whether the aviation related error is an acceptable error or an unacceptable error.

In some embodiments, initiating performance of one or more aviation related actions based at least in part on the processing of the aviation related error using the second portion 304 of the composite aviation operations verification model 300 may include initiating performance of an aviation related action that includes causing operation of one or more of the one or more verified devices 180.

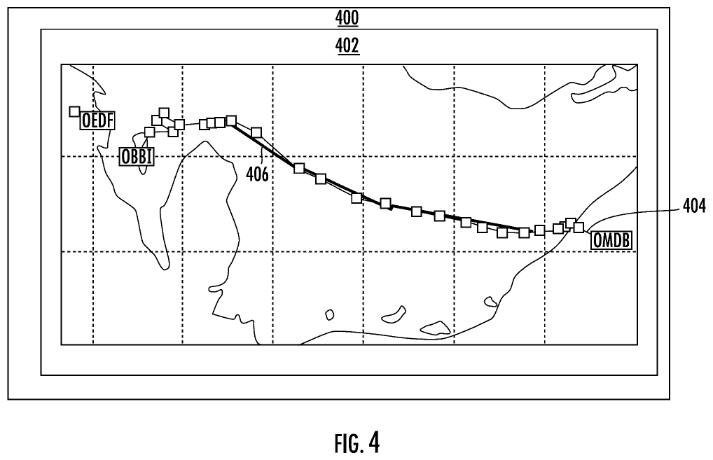

In some embodiments, for example, initiating performance of an aviation related action that includes causing operation of one or more of the one or more verified devices 180 may include causing one or more of the one or more verified devices 180 to display an interface component on an interface based at least in part on aviation data and/or error impact data. For example, as illustrated in FIG. 4, initiating performance of an aviation related action that includes causing operation of one or more of the one or more verified devices 180 may include causing one or more of the one or more verified devices 180 to display a trajectory interface component 402 on an interface 400 based at least in part on aviation data and/or error impact data. In this regard, the trajectory interface component 402 may be configured to display aviation data and/or error impact data that is representative of a planned trajectory 404 of the aircraft 110 based on a flight plan associated with the aviation data. Additionally, or alternatively, the trajectory interface component 402 may be configured to display aviation data and/or error impact data that is representative of an actual trajectory 406 of the aircraft 110 based on a flight plan associated with the aviation data and/or error impact data associated with the aviation data that indicates that the aviation data includes an acceptable error. In this regard, for example, the aircraft 110 may still use the flight plan because, although there is an aviation related error in the aviation data that causes an actual trajectory to be different than a planned trajectory, the error is an acceptable error (e.g., the deviations in trajectory between the actual trajectory and the planned trajectory are acceptable).

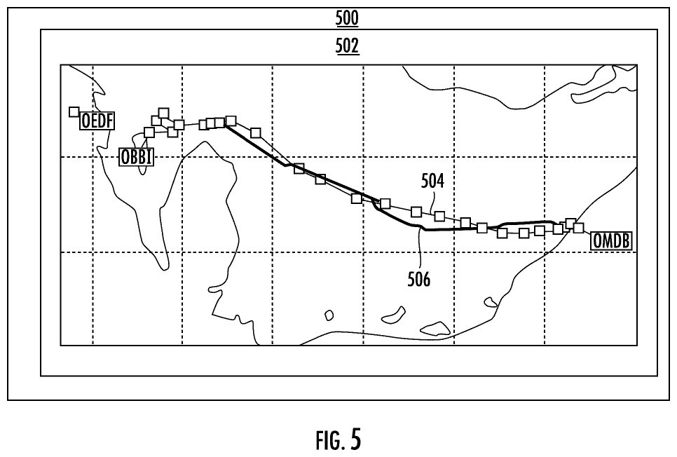

As another example, as illustrated in FIG. 5, initiating performance of an aviation related action that includes causing operation of one or more of the one or more verified devices 180 may include causing one or more of the one or more verified devices 180 to display a trajectory interface component 502 on an interface 500 based at least in part on aviation data and/or error impact data. In this regard, the trajectory interface component 502 may be configured to display aviation data and/or error impact data that is representative of a planned trajectory 504 of the aircraft 110 based on a flight plan associated with the aviation data. Additionally, or alternatively, the trajectory interface component 502 may be configured to display aviation data and/or error impact data that is representative of an actual trajectory 506 of the aircraft 110 based on a flight plan associated with the aviation data and/or error impact data associated with the aviation data that indicates that the aviation data includes an unacceptable error. In this regard, for example, the aircraft 110 may not be able to use the flight plan because there is an aviation related error associated with the aviation data that is an unacceptable error (e.g., the aviation related error causes the actual trajectory to deviate too much from the planned trajectory).

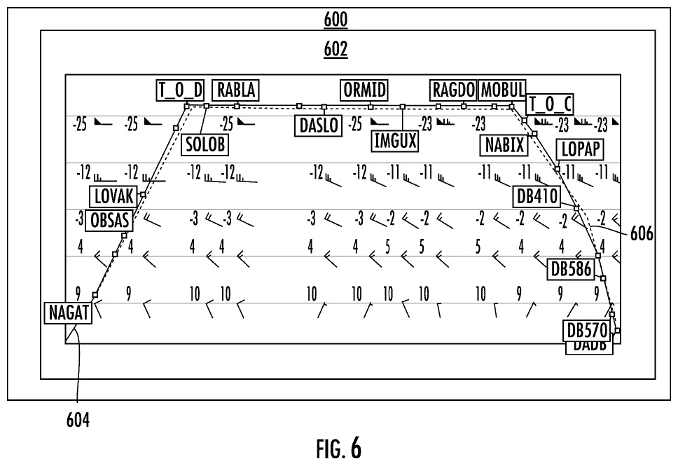

As another example, as illustrated in FIG. 6, initiating performance of an aviation related action that includes causing operation of one or more of the one or more verified devices 180 may include causing one or more of the one or more verified devices 180 to display an altitude interface component 602 on an interface 600 based at least in part on aviation data and/or error impact data. In this regard, the altitude interface component 602 may be configured to display aviation data and/or error impact data that is representative of a planned altitude 604 of the aircraft 110 based on a flight plan associated with the aviation data. Additionally, or alternatively, the altitude interface component 602 may be configured to display aviation data and/or error impact data that is representative of an actual altitude 606 of the aircraft 110 based on a flight plan associated with the aviation data and/or error impact data associated with the aviation data that indicates that the aviation data includes an acceptable error. In this regard, for example, the aircraft 110 may still use the flight plan because, although there is an aviation related error in the aviation data that causes an actual altitude to be different than a planned altitude, the error is an acceptable error (e.g., the deviations in altitude between the actual altitude and the planned altitude are acceptable).

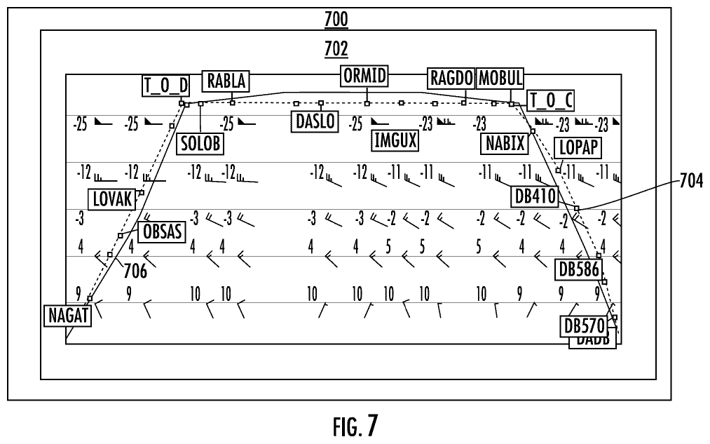

As another example, as illustrated in FIG. 7, initiating performance of an aviation related action that includes causing operation of one or more of the one or more verified devices 180 may include causing one or more of the one or more verified devices 180 to display an altitude interface component 702 on an interface 700 based at least in part on aviation data and/or error impact data. In this regard, the altitude interface component 702 may be configured to display aviation data and/or error impact data that is representative of a planned altitude 704 of the aircraft 110 based on a flight plan associated with the aviation data. Additionally, or alternatively, the altitude interface component 702 may be configured to display aviation data and/or error impact data that is representative of an actual altitude 706 of the aircraft 110 based on a flight plan associated with the aviation data and/or error impact data associated with the aviation data that indicates that the aviation data includes an unacceptable error. In this regard, for example, the aircraft 110 may not be able to use the flight plan because there is an aviation related error associated with the aviation data that is an unacceptable error (e.g., the aviation related error causes the actual altitude to deviate too much from the planned altitude).

In some embodiments, for example, initiating performance of an aviation related action that includes causing operation of one or more of the one or more verified devices 180 may include causing one or more of the one or more verified devices 180 to operate in accordance with a flight plan associated with the aviation data. For example, initiating performance of an aviation related action that includes causing operation of one or more of the one or more verified devices 180 may include causing a flight management system component of the aircraft 110 to operate the aircraft in accordance with a flight plan associated with the aviation data.

In some embodiments, for example, initiating performance of an aviation related action that includes causing operation of one or more of the one or more verified devices 180 may include causing one or more of the one or more verified devices 180 to make an adjustment to the aircraft. For example, initiating performance of an aviation related action that includes causing operation of one or more of the one or more verified devices 180 may include causing a flight management system component of the aircraft 110 to make an adjustment to the aircraft 110 (e.g., cause the aircraft to change its altitude, cause the aircraft to turn, etc.) when error impact indicates that there is an unacceptable error associated with the flight plan such that operation of the aircraft needs to be adjusted in a manner than deviates from the flight plan.

### EXAMPLE METHODS

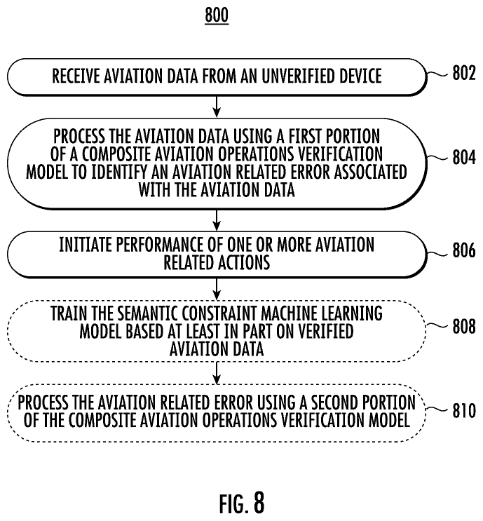

Referring now to FIG. 8, a flowchart providing an example method 800 is illustrated. In this regard, FIG. 8 illustrates operations that may be performed by the aviation operations verification apparatus (e.g., the mobile aviation operations verification apparatus 120, the onboard aviation operations verification apparatus 150, and/or the remote aviation operations verification apparatus 140), the aircraft 110, and/or the like. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method may include receiving aviation data from an unverified device. As described above, in some embodiments, aviation data may be one or more items of data representative of and/or associated with a flight plan of an aircraft (e.g., the aircraft). In some embodiments, a flight plan may represent a series of operations the aircraft may perform to complete a flight and/or a portion of a flight. Additionally, or alternatively, a flight plan may represent conditions associated with the aircraft performing the flight. In this regard, for example, aviation data may include one or more items of data representative of and/or associated with a required runway to perform a flight (e.g., a runway of a certain length based on the size of the aircraft). As another example, aviation data may include one or more items of data representative of and/or associated with required fuel to perform a flight. As another example, aviation data may include one or more items of data representative of and/or associated with a time of arrival at a waypoint in a flight. As another example, aviation data may include one or more items of data representative of and/or associated with potential cross track errors in a flight. As another example, aviation data may include one or more items of data representative of and/or associated with real time traffic associated with a flight (e.g., other aircraft that may impact a flight performed by the aircraft).

As another example, aviation data may include one or more items of data representative of and/or associated with altitude at various points in a flight. As another example, aviation data may include one or more items of data representative of and/or associated with weather associated with a flight. As another example, aviation data may include one or more items of data representative of and/or associated with airport conditions associated with a flight (e.g., origin airport and/or destination airport). As another example, aviation data may include one or more items of data representative of and/or associated with air traffic control commands associated with a flight. As another example, aviation data may include one or more items of data representative of and/or associated with location (e.g., GPS location) at various points in a flight. As another example, aviation data may include one or more items of data representative of and/or associated with operation algorithms associated with controlling the aircraft during a flight.

As shown in block 804, the method may include processing the aviation data using a first portion of a composite aviation operations verification model to identify an aviation related error associated with the aviation data. As described above, in some embodiments, an aviation related error may indicate that there is an error in a flight plan associated with the aviation data. In this regard, for example, an aviation related error may indicate that the aircraft may not be able to adhere to at least a portion of a flight plan.

In some embodiments, for example, an aviation related error may indicate that there is a range related error in the flight plan (e.g., the aircraft is not capable of traveling the distance indicated in the flight plan). As another example, an aviation related error may indicate that there is a nonexistent identifier in the flight plan (e.g., a nonexistent waypoint, airport, airway, and/or the like in a flight plan). As another example, an aviation related error may indicate that there is insufficient fuel to complete a flight plan. As another example, an aviation related error may indicate that a selected runway is insufficient for the size of the aircraft (e.g., the aircraft is a large aircraft that needs a longer runway than the selected runway). As another example, an aviation related error may indicate that the planned trajectory of the aircraft in a flight plan may result in a violation of a required navigational performance. As another example, an aviation related error may indicate that the fuel remaining at a waypoint may be too little to complete a flight associated with a flight plan. As another example, an aviation related error may indicate that a flight plan indicates an incorrect position (e.g., at a particular point in the flight). As another example, an aviation related error may indicate that a weight of the aircraft is incorrect for takeoff. As another example, an aviation related error may indicate that weather conditions will not enable a planned trajectory.

In some embodiments, an aviation related error may be semantic related error. For example, a semantic related error may be an aviation related error in which a flight plan indicates that the destination airport is a valid airport (e.g., KLAX) while the actual intended destination airport is a different airport (e.g., KPHX). In some embodiments, an aviation related error may be a syntactic related error. For example, a syntactic related error may be an aviation related error in which there is a syntactic related error in text that describes the flight plan.

In some embodiments, the first portion of the composite aviation operations verification model may include a syntactic validator component. In this regard, for example, processing the aviation data using the first portion of the composite aviation operations verification model may include the aviation operations verification apparatus (e.g., the mobile aviation operations verification apparatus, the onboard aviation operations verification apparatus, and/or the remote aviation operations verification apparatus) being configured to apply the aviation data to the syntactic validator component. In some embodiments, the syntactic validator component may be a data entity that describes parameters, hyper-parameters, and/or defined operations of a rules-based model (e.g., model including at least one of one or more rule-based layers) configured to at least in part identify an aviation related error associated with the aviation data using one or more syntactic based rules (e.g., to identify aviation related errors that are syntactic related errors).

In some embodiments, the first portion of the composite aviation operations verification model may include a semantic constraint check component. In this regard, for example, processing the aviation data using the first portion of the composite aviation operations verification model may include the aviation operations verification apparatus (e.g., the mobile aviation operations verification apparatus, the onboard aviation operations verification apparatus, and/or the remote aviation operations verification apparatus) being configured to apply the aviation data to the semantic constraint check component. In some embodiments, the semantic constraint check component may be a data entity that describes parameters, hyper-parameters, and/or defined operations of a rules-based model (e.g., model including at least one of one or more rule-based layers) configured to at least in part identify an aviation related error associated with the aviation data using one or more semantic based rules (e.g., to identify aviation related errors that are semantic related errors).

In some embodiments, the first portion of the composite aviation operations verification model may include a semantic constraint machine learning model. In this regard, for example, processing the aviation data using the first portion of the composite aviation operations verification model may include the aviation operations verification apparatus (e.g., the mobile aviation operations verification apparatus, the onboard aviation operations verification apparatus, and/or the remote aviation operations verification apparatus) being configured to apply the aviation data to the semantic constraint machine learning model.

In some embodiments, the semantic constraint machine learning model may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to at least in part identify an aviation related error associated with the aviation data using one or more machine learning techniques. The semantic constraint machine learning model may utilize one or more of any type of machine learning, rules-based, and/or artificial intelligence techniques including one or more of supervised learning (e.g., using user feedback), unsupervised learning, semi-supervised learning, reinforcement learning, computer vision techniques, sequence modeling techniques, language processing techniques, neural network techniques, and/or generative artificial intelligence techniques.

As shown in block 806, the method may include initiating performance of one or more aviation related actions. As described above, in some embodiments, initiating performance of one or more aviation related actions based at least in part on the aviation related error not being identified by the processing of the aviation data using the first portion of the composite aviation operations verification model may include initiating performance of an aviation related action that includes transmitting the aviation data to one or more of the one or more verified devices. In this regard, for example, the aviation operations verification apparatus may be configured to initiate performance of one or more aviation related actions when an aviation related error is not identified by the processing of the aviation data using the first portion of the composite aviation operations verification model. For example, the aviation operations verification apparatus may be configured to initiate performance of an aviation related action that includes transmitting the aviation data to a flight management system component of the aircraft (e.g., the flight management system component may be a verified device). In this regard, for example, the flight management system component may be configured to implement a flight plan, a portion of a flight plan, and/or an operation in a flight plan associated with the aviation data based at least in part on the transmitted aviation data.

In some embodiments, initiating performance of one or more aviation related actions based at least in part on the aviation related error not being identified by the processing of the aviation data using the first portion of the composite aviation operations verification model may include initiating performance of an aviation related action that includes causing operation of one or more of the one or more verified devices. For example, the aviation operations verification apparatus may be configured to initiate performance of an aviation related action that includes causing operation of a flight management system component of the aircraft (e.g., the flight management system component may be a verified device). In this regard, for example, the aviation operations verification apparatus may be configured to cause the flight management system component to implement a flight plan, a portion of a flight plan, and/or an operation in a flight plan associated with the aviation data based at least in part on the aviation data.

As shown in block 808, the method may optionally include training the semantic constraint machine learning model based at least in part on verified aviation data. As described above, in some embodiments, the aviation operations verification apparatus (e.g., the mobile aviation operations verification apparatus, the onboard aviation operations verification apparatus, and/or the remote aviation operations verification apparatus) may be configured to train the semantic constraint machine learning model. In this regard, for example, the aviation operations verification apparatus may be configured to train the semantic constraint machine learning model based at least in part on verified aviation data. In some embodiments, verified aviation data may be one or more items of data representative of and/or associated with a flight plan of an aircraft (e.g., the aircraft) that does not include any aviation related errors. For example, verified aviation data may be aviation data that was previously processed by the composite aviation operations verification model in which no aviation related errors were identified.

As shown in block 810, the method may optionally include processing the aviation related error using a second portion of the composite aviation operations verification model. As described above, in some embodiments, the second portion of the composite aviation operations verification model may include an uncertainty estimation component. In this regard, for example, processing the aviation related error using the second portion of the composite aviation operations verification model may include the aviation operations verification apparatus (e.g., the mobile aviation operations verification apparatus, the onboard aviation operations verification apparatus, and/or the remote aviation operations verification apparatus) being configured to apply the aviation related error to the uncertainty estimation component. In some embodiments, the aviation operations verification apparatus may apply the aviation related error to the uncertainty estimation component to generate error impact data.

In some embodiments, error impact data by one or more items of data representative of an impact of an aviation related error. In this regard, for example, error impact data may indicate whether an aviation related error is an acceptable error or an unacceptable error. In some embodiments, if an aviation related error is an acceptable error, the aircraft may be able to use a flight plan associated with the aviation data to perform a flight even though the flight plan includes an error. For example, if the flight plan indicates that the aircraft should maintain an altitude of 32,000 feet during a portion of the flight but the processing of the aviation data in the first portion of the composite aviation operations verification model identifies an aviation related error that indicates that the aircraft may be at 32,100 feet during the portion of the flight, the uncertainty estimation component may generate error impact data that indicates that the aviation related error is an acceptable error.

In some embodiments, if an aviation related error is an unacceptable error, the aircraft may not be able to use the flight plan associated with the aviation data to perform a flight. For example, if the flight plan indicates that the aircraft should land at a first runway but the processing of the aviation data in the first portion of the composite aviation operations verification model identifies an aviation related error that indicates that the first runway is too short of the aircraft to land at, the uncertainty estimation component may generate error impact data that indicates that the aviation related error is an unacceptable error.

In some embodiments, the uncertainty estimation component may be a data entity that describes parameters, hyper-parameters, and/or defined operations of a rules-based, machine learning model, and/or generative artificial intelligence model (e.g., model including at least one of one or more rule-based layers, one or more layers that depend on trained parameters, coefficients, and/or the like) configured to at least in part generate error impact data. The uncertainty estimation component may utilize one or more of any type of machine learning, rules-based, and/or artificial intelligence techniques including one or more of supervised learning (e.g., using user feedback), unsupervised learning, semi-supervised learning, reinforcement learning, computer vision techniques, sequence modeling techniques, language processing techniques, neural network techniques, and/or generative artificial intelligence techniques.

In some embodiments, the second portion of the composite aviation operations verification model may include an error handling component. In this regard, for example, processing the aviation related error using the second portion of the composite aviation operations verification model may include the aviation operations verification apparatus (e.g., the mobile aviation operations verification apparatus, the onboard aviation operations verification apparatus, and/or the remote aviation operations verification apparatus) being configured to apply error impact data to the error handling component. In some embodiments, the error handling component may be a data entity that describes parameters, hyper-parameters, and/or defined operations of a rules-based model (e.g., model including at least one of one or more rule-based layers) configured to at least in part handle error impact data and/or aviation data.

In some embodiments, the aviation operations verification apparatus (e.g., the mobile aviation operations verification apparatus, the onboard aviation operations verification apparatus, and/or the remote aviation operations verification apparatus) may be configured to initiate performance of one or more aviation related actions based at least in part on the processing of the aviation related error using the second portion of the composite aviation operations verification model. In some embodiments, the aviation operations verification apparatus may be configured to initiate performance of one or more aviation related actions based at least in part on the processing of the aviation related error using the second portion of the composite aviation operations verification model using the error handling component.

In some embodiments, initiating performance of one or more aviation related actions based at least in part on the processing of the aviation related error using the second portion of the composite aviation operations verification model may include initiating performance of an aviation related action that includes providing an indication of an identified aviation related error to one or more of the one or more unverified devices (e.g., using the error handling component). In this regard, the aviation operations verification apparatus may be configured to provide feedback to one or more of the one or more unverified devices when an aviation related error has been identified.

In some embodiments, initiating performance of one or more aviation related actions based at least in part on the processing of the aviation related error using the second portion of the composite aviation operations verification model may include initiating performance of an aviation related action that includes transmitting an aviation alert to one or more of the one or more verified devices (e.g., using the error handling component). In some embodiments, the transmitted aviation alert may include an indication that there is an aviation related error associated with the aviation data. In some embodiments, the transmitted aviation alert may indicate whether the aviation related error is an acceptable error or an unacceptable error.

In some embodiments, initiating performance of one or more aviation related actions based at least in part on the processing of the aviation related error using the second portion of the composite aviation operations verification model may include initiating performance of an aviation related action that includes causing operation of one or more of the one or more verified devices.

In some embodiments, for example, initiating performance of an aviation related action that includes causing operation of one or more of the one or more verified devices may include causing one or more of the one or more verified devices to display an interface component on an interface based at least in part on aviation data and/or error impact data.

In some embodiments, for example, initiating performance of an aviation related action that includes causing operation of one or more of the one or more verified devices may include causing one or more of the one or more verified devices to operate in accordance with a flight plan associated with the aviation data. For example, initiating performance of an aviation related action that includes causing operation of one or more of the one or more verified devices may include causing a flight management system component of the aircraft to operate the aircraft in accordance with a flight plan associated with the aviation data.

In some embodiments, for example, initiating performance of an aviation related action that includes causing operation of one or more of the one or more verified devices may include causing one or more of the one or more verified devices to make an adjustment to the aircraft. For example, initiating performance of an aviation related action that includes causing operation of one or more of the one or more verified devices may include causing a flight management system component of the aircraft to make an adjustment to the aircraft (e.g., cause the aircraft to change its altitude, cause the aircraft to turn, etc.) when error impact indicates that there is an unacceptable error associated with the flight plan such that operation of the aircraft needs to be adjusted in a manner than deviates from the flight plan.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
receiving aviation data from an unverified device;
processing the aviation data using a first portion of a composite aviation operations verification model to identify an aviation related error associated with the aviation data; and
in an instance in which the aviation related error is not identified in the aviation data, initiating performance of one or more aviation related actions based at least in part on the aviation related error not being identified by the processing of the aviation data using the first portion of the composite aviation operations verification model.

2. The method of claim 1, wherein initiating performance of the one or more aviation related actions based at least in part on the aviation related error not being identified by the processing of the aviation data using the first portion of the composite aviation operations verification model comprises:
initiating performance of a first aviation related action that comprises transmitting the aviation data to one or more verified devices.

3. The method of claim 2, wherein the verified device is a flight management system.

4. The method of claim 3, wherein the flight management system is physically located on an aircraft.

5. The method of claim 1, wherein initiating performance of the one or more aviation related actions based at least in part on the aviation related error not being identified by the processing of the aviation data using the first portion of the composite aviation operations verification model comprises:
initiating performance of a first aviation related action that comprises causing operation of one or more verified devices based at least in part on the aviation data.

6. The method of claim 1, wherein processing the aviation data using the first portion of the composite aviation operations verification model comprises applying the aviation data to a syntactic validator component of the first portion of the composite aviation operations verification model to identify the aviation related error.

7. The method of claim 1, wherein processing the aviation data using the first portion of the composite aviation operations verification model comprises applying the aviation data to a semantic constraint check component of the first portion of the composite aviation operations verification model to identify the aviation related error.

8. The method of claim 1, wherein processing the aviation data using the first portion of the composite aviation operations verification model comprises applying the aviation data to a semantic constraint machine learning model of the first portion of the composite aviation operations verification model to identify the aviation related error.

9. The method of claim 8, further comprising:
training the semantic constraint machine learning model based at least in part on verified aviation data.

10. The method of claim 1, further comprising:
in an instance in which the aviation related error is identified in the aviation data, processing the aviation related error using a second portion of the composite aviation operations verification model; and
initiating performance of one or more aviation related actions based at least in part on the processing of the aviation related error using the second portion of the composite aviation operations verification model.

11. The method of claim 10, wherein initiating performance of the one or more aviation related actions based at least in part on the processing of the aviation related error using the second portion of the composite aviation operations verification model comprises:
initiating performance of a first aviation related action that comprises transmitting an aviation alert to one or more verified devices.

12. The method of claim 10, wherein initiating performance of the one or more aviation related actions based at least in part on the processing of the aviation related error using the second portion of the composite aviation operations verification model comprises:
initiating performance of a first aviation related action that comprises providing an indication of the aviation related error to the unverified device.

13. The method of claim 10, wherein initiating performance of the one or more aviation related actions based at least in part on the processing of the aviation related error using the second portion of the composite aviation operations verification model comprises:
initiating performance of a first aviation related action that comprises causing operation of one or more verified devices based at least in part on the aviation related error.

14. The method of claim 10, wherein processing the aviation data using the second portion of the composite aviation operations verification model comprise applying the aviation related error to an uncertainty estimation component of the second portion of the composite aviation operations verification model to generate error impact data.

15. The method of claim 14, wherein processing the aviation data using the second portion of the composite aviation operations verification model comprise applying the error impact data to an error handling component of the second portion of the composite aviation operations verification model.

16. An apparatus comprising at least one processor and at least one non-transitory memory including computer-coded instructions thereon, the computer coded instructions, with the at least one processor, cause the apparatus to:
receive aviation data from an unverified device;
process the aviation data using a first portion of a composite aviation operations verification model to identify an aviation related error associated with the aviation data; and
in an instance in which the aviation related error is not identified in the aviation data, initiate performance of one or more aviation related actions based at least in part on the aviation related error not being identified by the processing of the aviation data using the first portion of the composite aviation operations verification model.

17. The apparatus of claim 16, wherein processing the aviation data using the first portion of the composite aviation operations verification model comprises applying the aviation data to a syntactic validator component of the first portion of the composite aviation operations verification model to identify the aviation related error.

18. The apparatus of claim 16, wherein processing the aviation data using the first portion of the composite aviation operations verification model comprises applying the aviation data to a semantic constraint check component of the first portion of the composite aviation operations verification model to identify the aviation related error.

19. The apparatus of claim 16, wherein processing the aviation data using the first portion of the composite aviation operations verification model comprises applying the aviation data to a semantic constraint machine learning model of the first portion of the composite aviation operations verification model to identify the aviation related error.

20. A computer program product comprising at least one non-transitory computer-readable storage medium having computer program code stored thereon that, in execution with at least one processor, configures the computer program product for:
receive aviation data from an unverified device;
process the aviation data using a first portion of a composite aviation operations verification model to identify an aviation related error associated with the aviation data; and
in an instance in which the aviation related error is not identified in the aviation data, initiate performance of one or more aviation related actions based at least in part on the aviation related error not being identified by the processing of the aviation data using the first portion of the composite aviation operations verification model.
